(19) United States
(12) Patent Application Publication
(10) Pub. No.: US 2021/0227803 A1
(43) Pub. Date: Jul. 29, 2021

(54) MARINE FARMING SYSTEM

(71) Applicant: WHITAFERD LLC, Concord, MA (US)

(72) Inventor: Kurt Josef SEIFERT, Vienna, VA (US)

(21) Appl. No.: 17/264,158

(22) PCT Filed: Jul. 30, 2019
(86) PCT No.: PCT/US2019/044033

§ 371 Date: Jan. 28, 2021

Related U.S. Application Data
(60) Provisional application No. 62/711,898, filed on Jul. 30, 2018.

(51) Int. Cl. A01K 61/54; A01K 63/06; A01K 63/04

(52) U.S. Cl. CPC A01K 61/54; A01K 63/045; A01K 63/065

(57) ABSTRACT

Provided are systems and methods for farming bivalves, such as clams, oysters and scallops, using the principles of geothermal cooling. The system comprises a housing for containing the bivalves and a fluid distribution system configured to move water from a relatively warm body of water, such as an inlet to an ocean, to the housing. The fluid distribution system includes a conduit having an outer surface in thermal contact with a natural thermal reservoir with a temperature cooler than the body of water. The conduit is configured to transfer energy from the water to the thermal reservoir to cool the water and to pump nutrient-rich cooler water through the housing containing the bivalves.

### TECHNICAL FIELD

This disclosure relates to systems and methods for farming or cultivating marine animals, and in particular bivalves such as oysters, clams and scallops.

### BACKGROUND OF THE INVENTION

Aquaculture is the farming of water-based organisms, such as fish, bivalves, crustaceans, aquatic plants and algae, in an aquatic environment. Aquaculture involves cultivating freshwater or saltwater populations under controlled conditions. In some instances, these controlled environments protect the organisms from natural conditions that can be harmful to certain animals or plants, such as red tides. Red tides are large concentrations of aquatic microorganisms, such as protozoans and unicellular algae, which produce toxins that can be harmful to marine life. Government restrictions to preserve populations of certain native species have also increased the demand for seafood produced in controlled natural or artificial environments.

Marine farming is an aquaculture practice in which bivalves, such as oysters, are bred and raised mainly for their pearls, shells and inner organ tissue, which is eaten. Oysters naturally grow in estuarine bodies of brackish water, i.e., water containing more salinity than fresh water, but not as much as sea water. When farmed, the temperature and salinity of the water are controlled (or at least monitored) so as to induce spawning and fertilization, as well as to spread the rate of maturation, which can take several years.

Marine farming of oysters is constrained due to the scarcity and cost of suitable land-based environments for cultivating the oysters. Recessed coastal bodies of water, such as bays and coves, provide convenient and relatively inexpensive locations for accessing saltwater and the requisite nutrients for growing oysters. However, many of these coastal areas are too warm to be ideally suited for the cultivation of oysters. For example, at the edges of certain bays, such as the Chesapeake Bay in Maryland, the average water temperature can reach up to an average of about 84 degrees F. Bivalves, however, can only be cultivated in healthy and large populations under lower water temperatures, such as temperatures in the range of about 60 to 68 degrees F.

It would therefore be desirable to provide a system and method of cultivating or farming marine animals, such as oysters, clams and scallops, in the convenience of a smaller coastal body of water, such as a bay or a cove, at lower water temperatures suitable for such bivalves.

### SUMMARY OF THE INVENTION

This disclosure generally provides a system and method for raising and cultivating marine animals such as bivalves, e.g., clams, oysters and scallops, using the principles of geothermal cooling. The system comprises a housing for containing the bivalves and a fluid distribution system configured to move water from a relatively warm body of water to the housing. The fluid distribution system includes a conduit in thermal contact with a natural thermal reservoir having a temperature cooler than the body of water. The conduit is configured to transfer energy from the water to the thermal reservoir to cool the water such that a temperature of the water is substantially reduced between the body of water and the housing. The system utilizes the colder temperature of nearby thermal reservoirs to cool the water and create a suitable environment for cultivating the bivalves.

In certain embodiments, the body of water is an inlet of an ocean, such as a bay or cove, that contains salt water with a sufficient amount of nutrients to feed the oysters and is easily accessible for a land-based farming system. The bay may have average temperatures greater than about 80 degrees Fahrenheit. According to the invention, the relatively warm ocean water is pumped from the bay through the natural thermal reservoir until it is cooled to a suitable temperature for the oysters, preferably at least 10 degrees cooler than the water in the bay, and more preferably about 60 to 68 degrees Fahrenheit.

In one embodiment, the natural thermal reservoir is the earth and the conduit is configured to use the earth as a heat sink. The conduit preferably extends from the inlet below the surface of the earth to the housing and is configured to transfer a sufficient amount of energy from the water to the earth to cool the water to a temperature range suitable for the oysters. Specifically, the conduit is designed with an outer surface area and a length configured to transfer energy from the water to the earth and cool the water to the desired temperatures within the housing. In an exemplary embodiment, the conduit resides at a depth of at least 2 feet below the earth's surface, where the average temperature is typically around 54 degrees Fahrenheit.

The housing preferably comprises a pool of water surrounding a plurality of casings, each having a sufficient volume to house numerous oysters therein. The pool of water has an inlet coupled to the conduit for receiving the cooled water and an outlet coupled to the bay to discharge the water back to the bay. In certain embodiments, the casings are stacked on top of each other within the pool of water to optimize the number of oysters that may be housed in a given volume of water. The water is preferably circulated throughout the casings such that the oysters have access to the nutrients within the water.

In certain embodiments, the housing further comprises a downweller and an upweller within the pool of water. Each of the downweller and upweller is configured to house a plurality of casings holding juvenile oysters therein. The downweller has an upper portion with an inlet and a lower portion with an outlet to allow water to descend through the downweller. The upweller has a lower portion with an inlet and an upper portion with an outlet to pump water upwards through the upweller past the juvenile oysters. The downweller and upweller create the natural conditions suitable for young oysters to mature and grow into adults.

In a preferred embodiment, the farming system further includes a filter coupled to the inlet of the conduit for filtering out animals, plants, debris or other unwanted matter from the water. The filter is preferably configured to allow water and nutrients to pass therethrough while blocking larger substances. In one embodiment, the filter includes a net with one or more floatation devices and positioned to float in the water and substantially surround the conduit inlet. In another embodiment, the filter comprises a mesh net covering the inlet and having openings of about 0.25 to 0.125 inches in diameter. In yet another embodiment, the filter comprises a cap configured to couple to the inlet and substantially surround the inlet to filter out substances from passing therethrough.

In another aspect of the invention, a method for farming bivalves comprises containing a plurality of bivalves within a housing, circulating water from a body of water through a thermal reservoir having a temperature cooler than the body of water to cool the water and passing the cooled water through the housing such that the bivalves are immersed within the water. In certain embodiments, the thermal reservoir is the earth and the method includes pumping the water from a nearby bay or other inlet of the ocean through the earth to the housing. The water is circulated underneath the surface of the earth (preferably at a depth of at least 2 feet) until it has been cooled to a sufficient temperature for cultivating the oysters.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

FIG. 1 is a schematic illustration of a marine farming system according to the present invention;

FIG. 2 is a top view of the marine farming system of FIG. 1;

FIG. 3 is a top view of a bivalve housing of the marine farming system of FIG. 1;

FIG. 4A illustrates one embodiment of a casing of the bivalve housing of FIG. 3;

FIG. 4B illustrates another embodiment of a casing of the bivalve housing of FIG. 3;

FIG. 5A illustrates an upwelling casing of the marine farming system according to certain embodiments of the present disclosure;

FIG. 5B illustrates a downwelling casing of the marine farming system according to certain embodiments of the present disclosure;

FIG. 6A illustrates one embodiment of a tubing system of the marine farming system of the present invention;

FIG. 6B illustrates another embodiment of a tubing system of the marine farming system of the present invention;

FIG. 7A is a top view of a filtering assembly of the marine farming system of the present invention;

FIG. 7B. is a side view of the filtering assembly of FIG. 7A; and

FIG. 7C is a cross-sectional view of one portion of the filtering assembly of FIG. 7A.

### DETAILED DESCRIPTION OF THE EMBODIMENTS

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting. Any molecular weight or molecular mass values are approximate and are provided only for description.

While the following disclosure is presented specifically with respect to the farming of oysters, it should be appreciated that the systems and methods of the present invention may be applicable to the farming of other marine animals and plants, such as other bivalves (e.g., scallops, claims, mollusks and the like), fish, shrimp and other crustaceans, aquatic plants, algae and other water-based organisms.

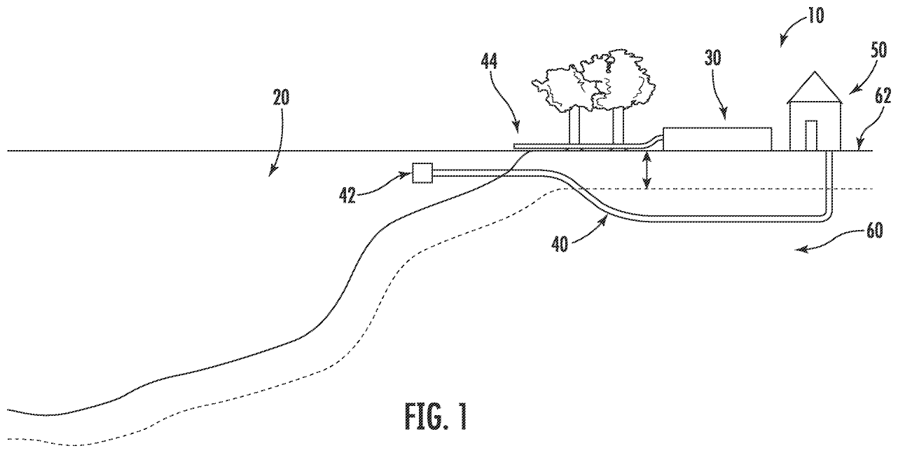

Referring now to FIG. 1, a marine farming system 10 according to the present invention is preferably situated adjacent to or near a large body of water, such as an ocean bay 20, estuary, cove, gulf, sound, bight, fjord, or the like, that includes a sufficient amount of nutrients, such as phytoplankton and/or algae that oysters can filter through their gills. In preferred embodiments, the body of water will contain salt water, e.g., seawater or brackish water, although it should be understood that the present invention could also be envisioned for use in fresh water locations, such as lakes or rivers. Farming system 10 generally comprises a housing 30 for cultivating and growing the oysters (not shown), a fluid conduit 40 fluidly coupling bay 20 to housing 30 and a pump 50 or other suitable device for moving water from bay 20 through housing 30. Fluid conduit 40 preferably includes an inlet 42 and an outlet 44 disposed in bay 20 such that the water passing through housing 30 can be recycled back into bay 20.

Fluid conduit 40 passes through a thermal reservoir having a temperature that is lower than the temperature of bay 20. Preferably, the thermal reservoir will be natural and will have sufficient heat capacity to maintain an effectively constant temperature while it is in thermal contact with the farming system of the present invention. In one embodiment, the large thermal reservoir is the earth 60 and the marine system of the invention is configured to use the earth 60 as a heat sink for cooling the water from bay 20. Preferably, fluid conduit 40 passes below the surface 62 of the earth 60, preferably at least one foot below the surface and more preferably at least 2 feet below the surface. The temperature of the earth is approximately 54 degrees F. at this depth, which is below the ideal temperature for cultivating and growing oysters (i.e., about 60 to 68 degrees Fahrenheit).

Of course, it will be understood that other thermal reservoirs or heat sinks can be used with the present invention. For example, a colder body of water, such as deeper parts of the ocean, a lake, river, glacier or the like, may be used as a natural thermal reservoir.

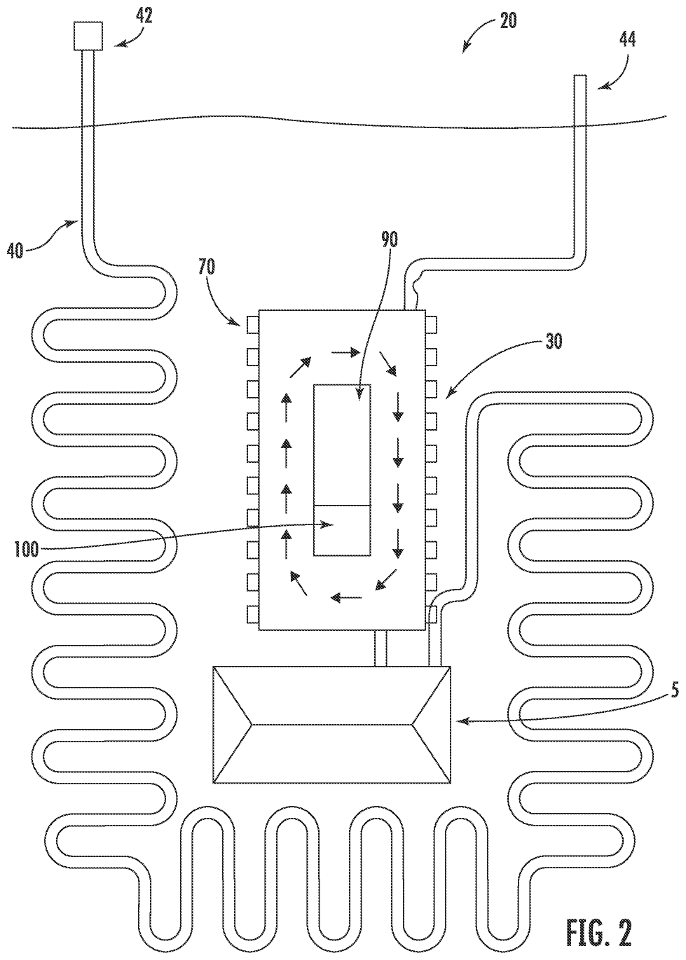

Referring now to FIG. 2, fluid conduit 40 extends from bay 20 to pump 50 and housing 30 before it returns to bay 20. In the preferred embodiment, fluid conduit 40 has a length between bay 20 and housing 30 that is sufficiently long to allow the earth 60 to cool the water flowing therethrough to the ideal temperature of about 60 to 68 degrees Fahrenheit. In an exemplary embodiment, the water is cooled by at least 10 degrees Fahrenheit. The specific length of conduit 40 will depend on a number of factors, such as the actual temperature of bay 20 (which may be over 80 degrees Fahrenheit), the ideal water temperature within housing 30, the velocity of the water passing through fluid conduit 40, the depth of conduit 40 within the earth 60 and the rate of heat transfer through the outer surface of conduit 40.

Marine system 10 may further include a reheater (not shown) located between housing 30 and outlet 42 to reheat discarded water flowing out of housing 30. This allows the water to be reheated to its original temperature before returning to the bay 20.

Pump 50 may be any suitable mechanism for moving water through conduit 40 by mechanical action, such as direct lift, positive displacement, impulse, velocity, gravity, steam and the like. Pump 50 is preferably designed to provide a variable velocity to the water passing through conduit 40 so that the operator can vary the amount of cooling of the water. Environmental conditions, such as climate or temperature, may change and require a change in the rate of cooling within conduit 40. Alternatively, the oysters may require different ideal temperatures during different stages of their development. In either case, the velocity of the water can be varied to ensure that the temperature arriving at housing 30 is optimal.

Pump 50 may operate via many different energy sources, such as electricity, thermal energy, wind power, solar, etc. In one embodiment, farming system 10 includes a plurality of solar panels 70 extending around housing 30 and coupled to pump 50 to provide some or all of the energy required to operate pump 50.

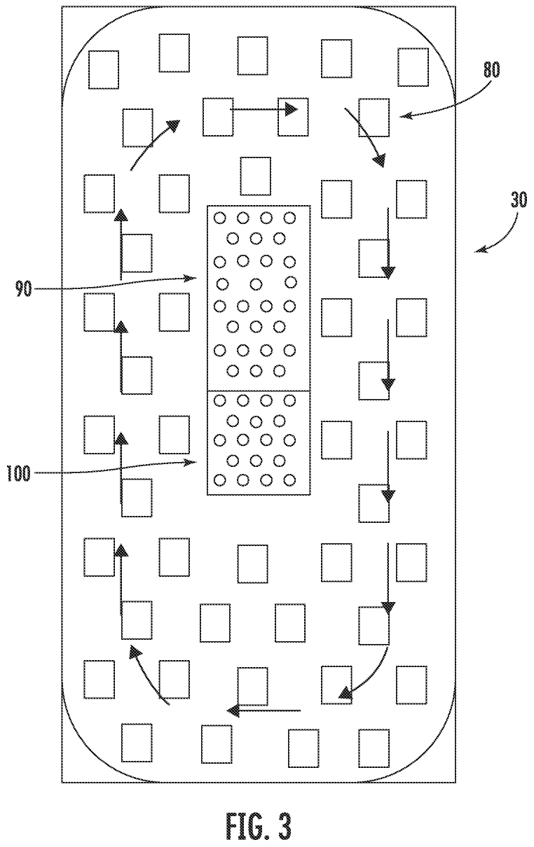

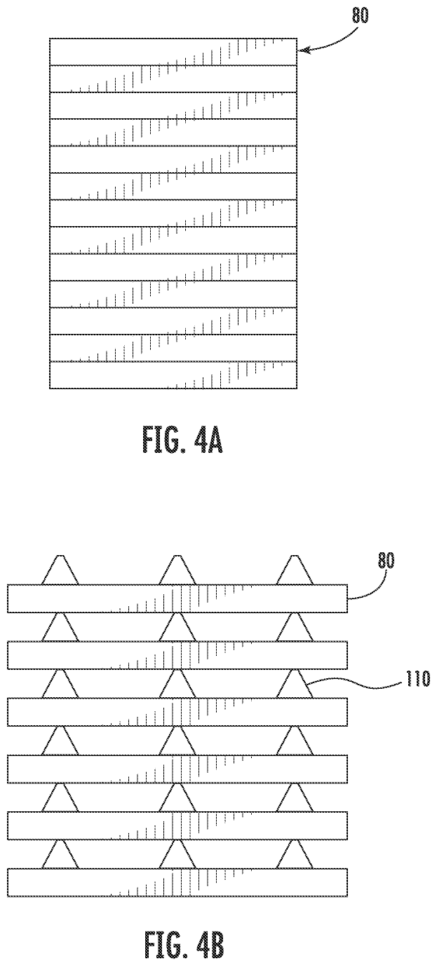

Referring now to FIG. 3, housing 30 preferably comprises a large pool of circulating water with a plurality of cases 80 stacked vertically upon each other (see FIGS. 4A and 4B) within the pool of water. Each case 80 is preferably sized to house between about 1,000 to 2,000 adult oysters or about 2,000 to 4,000 juvenile oysters. The oysters are preferably contained within mesh bags (not shown) or another suitable container within cases 80. Of course, it will be understood that other configurations can be used with the present invention. For example, the cases 80 may be situated side-to-side with each other. Alternatively, the mesh bags may be tethered to the housing and float within the pool of water (i.e., without any casings).

Housing 30 further comprises an incubator for juvenile oysters to grow and mature into adults. Young oysters typically require different conditions to grow than adult oysters. In the preferred embodiment, the incubators comprise at least one downweller 90 and at least one upweller 100 (discussed in more detail below). Preferably, the water is pumped through housing 30 such that it passes through cases 80 and both downweller 90 and upweller 100. The deliberate flow of water through the pool allows nutrient-rich ocean water to flow through the casings and result in healthier, more plump and better tasting oysters.

As shown in FIG. 4A, cases 80 may be stacked on top of each other with little to no space therebetween. This maximizes the amount of oysters that may be housed in one stack of cases 80. In another embodiment shown in FIG. 4B, housing 30 further comprises a number of spacers 110 between each of the cases 80. Spacers 110 serve to provide more space between cases 80 and facilitate loading and unloading of individual cases 80.

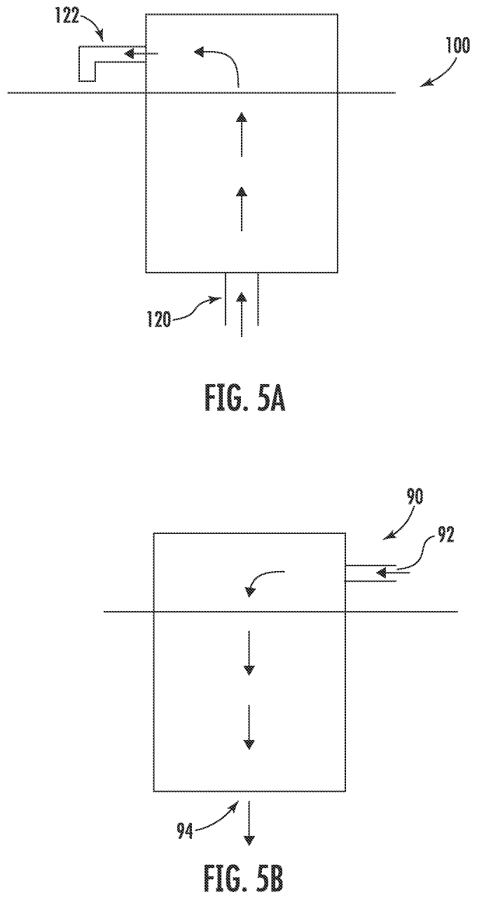

Referring now to FIGS. 5A and 5B, upweller 100 preferably comprises an open container, such as a 5 gallon bucket, having an inlet 120 in a lower portion of upweller 100 and an outlet 122 in an upper portion of upweller 100. Water is pumped through inlet 120 upwards through upweller until it exits outlet 122. Downweller 90 comprises a similar container except that the inlet 92 is in the upper portion of downweller 90 and the outlet 94 is in the lower portion. Water can be pumped downwards through downweller 90, or it may just displace downwards through the operation of gravity. Juvenile oysters are preferably housed within upweller 100 and downweller 90 until they are large enough to be placed into the mesh bags in casings 80.

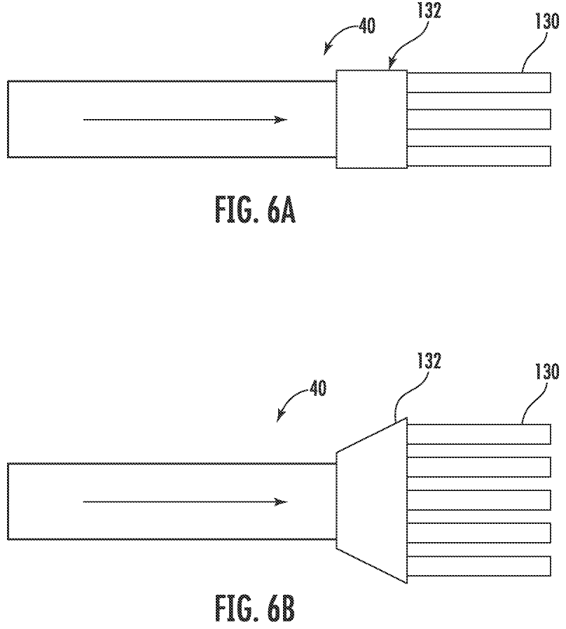

Referring now to FIGS. 6A and 6B, fluid conduit 40 preferably has a sufficient outer surface area to cool the water flowing therethrough to the ideal temperature before the water reaches housing 30. In one embodiment, fluid conduit 40 includes a plurality of pipes 130 extending from inlet 42 and through the earth 60 to housing 340. Inlet 42 preferably has a cross-sectional area of at least about 8 inches and pipes 130 preferably each have a cross-sectional area of about 0.5 to 1.5 inches, preferably about 1 inch, and wall thicknesses of about 0.05 to about 0.15 inches. Pipes 130 comprise a suitable material for conducting thermal energy through their outer surfaces via thermal conduction, such as metal or another suitable thermal conductor. In one embodiment (shown in FIG. 6B), pipes 130 are connected to inlet 42 via a pipe fitting 132 that extends the overall cross-sectional area of the conduit, thereby allowing a larger number of pipes 130 to extend from inlet 42. Pipes 130 may be housed within a larger fluid conduit as they pass through the earth 60, or they may be separated such that each pipe 130 is surrounded by the earth 60 to facilitate the transfer of energy from the water to the earth.

Pipe 130 are preferably designed to create the optimal current of water flowing into the pool of water within housing 30. The velocity of the water is preferably selected to ensure that the oysters have sufficient time to absorb nutrients as the water flows through their gills. In certain embodiments, a clockwise or counterclockwise current will be created within the pool to ensure that water flows throughout all of the casing 80 housed therein. Of course, other configurations are possible. For example, cases 80 may be situated in multiple rows or columns throughout the housing, with the water flowing in one direction through a row and then in the reverse direction through an adjacent row. Alternatively, cases 80 may be aligned in a single row or column with the water flowing straight through the housing.

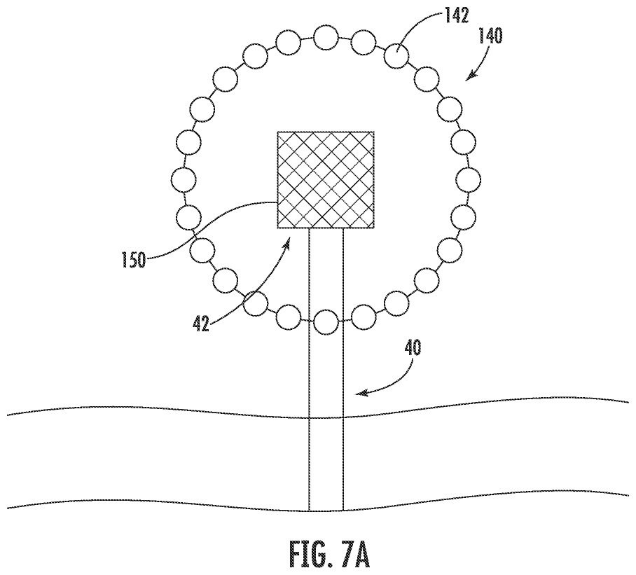

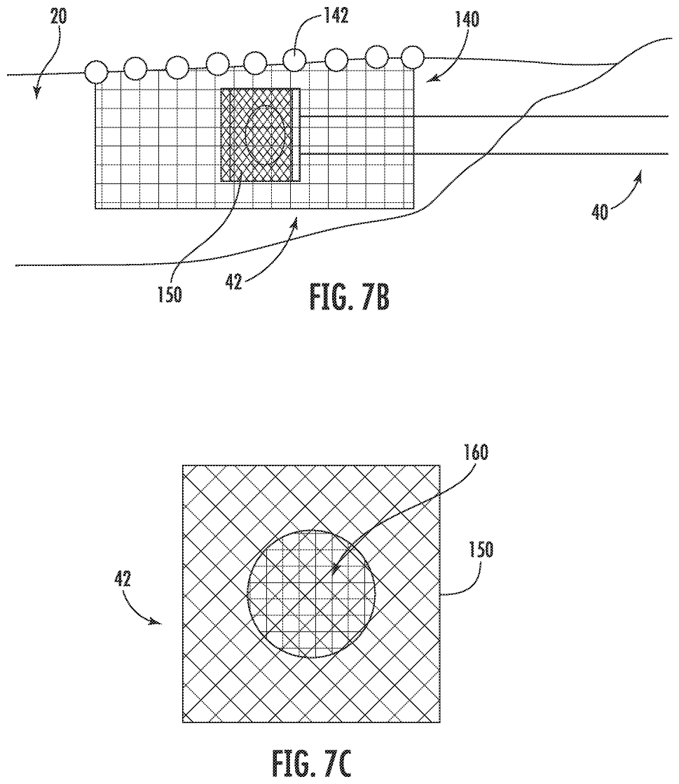

Referring now to FIGS. 7A-7C, marine system 10 preferably includes a filtering system to allow the passage of water and nutrients, while preventing or at least inhibiting the ingress of unwanted animals, plants, seaweed, jellyfish or other ocean debris into system 10. The filtering system preferably comprises a plurality of openings having diameters in the range of about 0.05 to about 0.5 inches, more preferably about 0.125 to about 0.25 inches.

In one embodiment, the filtering system includes a boom area net 140 surrounding inlet 42. As shown, boom area net 140 preferably comprises a plurality of floatation devices 142 attached to a net 144 that surround inlet 42. Boom area net 140 can be considered as a first line of defense for filtering larger substances from the area around inlet 42. Filtering system may further include a cap filter 150 coupled to conduit 40 around inlet 42. Cap filter 150 preferably comprises a substantially cubical filter that can be attached to the end of conduit 40 to provide a second line of defense. In addition to, or alternatively, the filtering system may further comprise a mesh lining 160 placed directly across the opening of inlet 42.

While the invention has been described in detail herein in accordance with certain preferred embodiments thereof, many modifications and changes therein may be effected by those skilled in the art. Accordingly, the foregoing disclosure should not be construed to be limited thereby but should be construed to include such aforementioned obvious variations and be limited only by the spirit and scope of the following claims.

1. A system for raising bivalves comprising:
a housing having an interior configured for containing a plurality of bivalves; and
a fluid distribution system configured to move water from a body of water to the housing, wherein the fluid distribution system includes a conduit in thermal contact with a thermal reservoir having a temperature cooler than the body of water, the fluid distribution system being configured to cool the water such that a temperature of the water is substantially reduced between the body of water and the housing.

2. The system of claim 1 wherein the body of water has a first temperature and the water in the housing has a second temperature, the first temperature being at least 10 degrees Fahrenheit higher than the second temperature.

3. The system of claim 1 wherein the fluid distribution system comprises a pump coupled to the conduit and configured to move the water through the conduit past the thermal reservoir and through the housing.

4. The system of claim 1 wherein the fluid distribution system is configured to immerse the bivalves within the water.

5. The system of claim 1 wherein the thermal reservoir is the earth.

6. The system of claim 5 wherein at least a portion of the conduit is positioned at least 2 feet under a surface of the earth.

7. (canceled)

8. The system of claim 1 wherein the body of water is an inlet of an ocean.

9. The system of claim 1 wherein the bivalves comprise oysters and the body of water contains nutrients for the oysters.

10. The system of claim 1 further comprising a discharge conduit having an inlet coupled to the housing and an outlet coupled to the body of water for discharging the water back into the body of water.

11. The system of claim 1 wherein the conduit comprises a plurality of tubes each having an inlet adapted for receiving the water from the body of water, wherein each tube has an outer surface in thermal contact with the thermal reservoir.

12. The system of claim 1 further comprising a filter coupled to the inlet of the conduit and configured to allow the passage of water and nutrients and filter out animals and plants from the water.

13. (canceled)

14. The system of claim 1 wherein the housing comprises at least one casing for housing the bivalves, wherein the casing comprises a lower portion and an upper portion, the lower portion being fluidly coupled to the housing inlet such that the water passes upwards through the casing.

15. (canceled)

16. The system of claim 14 wherein the casing comprises a lower portion and an upper portion, the upper portion being fluidly coupled to the housing inlet such that the water passes downward through the casing, the system further comprising a reheater coupled to the discharge conduit and configured to reheat the water after the water has passed through the housing.

17-20. (canceled)

21. A method for raising bivalves comprising:
containing a plurality of bivalves in a housing;
circulating water from a body of water through a thermal reservoir having a temperature cooler than the body of water;
cooling the water with the thermal reservoir; and
moving the water through the housing such that the bivalves are immersed within the water.

22. The method of claim 21, wherein the thermal reservoir is the earth.

23. The method of claim 21, further comprising pumping water from the body of water through the earth at least 2 feet below a surface of the earth for a sufficient period of time to cool the water.

24. The method of claim 21, wherein the body of water is an inlet of an ocean and the bivalves comprise oysters.

25. (canceled)

26. The method of claim 21, wherein the bivalves are housed within one or more casings within the housing, the method further comprising pumping the water from a lower portion of the casing, through the casing past the bivalves, to an upper portion of the casing.

27. (canceled)

28. The method of claim 26 further comprising pumping the water into an upper portion of the casing such that the water descends past the bivalves to a lower portion of the casing and discharging the water back into the body of water after the water has passed through the housing.

29. (canceled)

30. The method of claim 21 further comprising filtering out animals and plants from the water and allowing passage of water and nutrients to the housing.

31. The method of claim 21 further comprising pumping the water through a plurality of tubes through the thermal reservoir such that energy passes from the water through the tubes to the thermal reservoir.

32. The method of claim 21 further comprising cooling the water from a temperature greater than about 80 degrees Fahrenheit to a temperature between about 60 to about 68 degrees Fahrenheit.
